(19) United States
(12) Patent Application Publication
(10) Pub. No.: US 2004/0051920 A1
(43) Pub. Date: Mar. 18, 2004

(54) Method of producing a computer generated hologram

(76) Inventor: Colin D. Cameron, Worcestershire (GB)

Correspondence Address: NIXON & VANDERHYE, PC, 1100 N GLEBE ROAD, 8TH FLOOR, ARLINGTON, VA, 22201-4714, US

(21) Appl. No.: 10/415,956

(22) PCT Filed: Nov. 6, 2001
(86) PCT No.: PCT/GB01/04899

(51) Int. Cl. G02B 5/32

(52) U.S. Cl. 359/15

(57) ABSTRACT

An improved method of producing an interference based computer generated hologram (CGH), where pixels in the CGH design plane and/or object points on the virtual 3D object are grouped together. Occlusion and rendering properties are then calculated for one pixel or one object point of each group, but are used in calculations relating to all pixels or object points of that group. The pixel and object point grouping is used only for occlusion and rendering calculations and phase properties are still determined on a pixel by pixel basis. This method reduces the number of calculations required to produce a CGH, but retains the resolution related to the shape of the 3D image.

This invention relates to an improved method of producing an interference based Computer Generated Hologram (CGH).

A person skilled in the art would be aware of the various approaches that can be used to give a visual perception of 3D. Examples include stereo, auto-stereo, swept volume, integral photography, stereograms and holography. Only holography allows the generation of a real, 3D image which is accessible to all users and has all psychological and physiological cues present.

Classical interferometric holography is well known to those skilled in the art. Light scattered from an object interferes with a reference beam and forms an intensity pattern which can be recorded, for example, on photographic film. To reconstruct an image, the recorded interference pattern modulates a conjugate reference beam of light so that a replica of the original wavefront is reproduced. This wavefront further propagates in space and gives the viewer, or viewers, the full impression that the object really exists in space.

Unlike classical holograms, in a computer generated hologram (CGH) the object used to form the hologram need only exist as a mathematical description. The physical interference of light is replaced by a calculation to determine the appropriate interference pattern on the CGH design plane (CDP) for the given object. Once calculated, the interference pattern may be written to a device capable of light wave modulation. If an updateable 3D image is required the calculated pattern can be written to a reconfigurable device, such as an electrically addressed spatial light modulator (SLM). As with conventional holograms, the 3D image is produced from the modulation of an incident beam of light.

Several techniques of calculating the interference pattern of a virtual object are known to those skilled in the art. For example, Fourier based “ping-pong” methods (Ichioka et. al., Applied Optics 10, 403-11, 1971) and coherent ray tracing techniques (M. Lucente, Jrnl of electronic imaging 2(1), 28-34, January 1993).

Although the ping-pong method is simple to implement, it is limited to generating images of self-luminous objects without full rendering and lighting effects. To calculate a CGH interference pattern that is capable of producing very high resolution images, and which includes lighting effects and surface reflections properties, generally requires coherent ray tracing (CRT) calculations to be undertaken.

CRT techniques, which essentially implement a 3D scalar diffraction integral, simulates closely the propagation of light in a conventional interferometric hologram recording. The core of the calculation is a linear summation of the E-field contribution from each point on the virtual 3D object to a single given pixel of the CDP. The summation must then be repeated for each CDP pixel. To produce a CGH with acceptable image size and field of view thus requires many ray tracing calculations and will have a high associated computational load.

It is an aim of the present invention to reduce the number of calculations which are necessary to produce an-interference based CGH of a given image size and field of view.

According to the first aspect of this invention a method for producing an interference based computer generated hologram (CGH) comprises the steps of,

i) defining a number of object points; and

ii) defining a plurality of CGH pixels in a CGH design plane; and

iii) determining the total amplitude of light at each CGH pixel contributed by all non-occluded object points; and

iv) determining the optical path-length between each CGH pixel and each non-occluded object point; and

v) calculating the total electric field at each CGH pixel from the amplitude, occlusion and optical path-length information; and

vi) determining a CGH interference pattern from the total electric field calculated for each CGH pixel,

wherein, the occlusion information and amplitude contribution from at least some image points to at least some CGH pixels is taken to be the same as previously determined occlusion information and amplitude contributions.

In a preferred embodiment, the amplitude and occlusion information calculated for a particular CGH pixel is used in the total electric field calculation of two or more CGH pixels.

In particular, a macro-processing grid (MPG) may be formed from a plurality of MPG cells, wherein each MPG cell comprises a group of CGH design plane pixels and wherein the amplitude and occlusion information calculated for one CGH pixel of each MPG cell is used in the total electric field calculation of all pixels in that MPG cell.

Preferably, the MPG is a regular array of adjacent MPG cells and each MPG cell is a regular array of adjacent CGH design plane pixels. In such a case, the amplitude and occlusion information may be calculated only for a central point of the MPG.

In another preferred embodiment object points form object point clusters (OPCs) wherein each OPC comprises two or more object points and wherein the amplitude contribution of each object point in the OPC is taken, for the purpose of calculating occlusion effects and the amplitude at each CGH pixel, to be that calculated for one point of the OPC.

Preferably, the OPC will contain two or more object points which are grouped into primitive shapes. Furthermore, the number of object points in each OPC may vary according to the facet size of the particular part of the virtual 3D image. For example, it may be appropriate to have fewer object point in an OPC that corresponds to a part of the virtual 3D image which has small facets, whereas more object point in each OPC would be acceptable for a part of the image with larger facet sizes.

In an another preferred embodiment, the calculation of an interference based CGH further comprises the step of calculating the effect on light of a lens placed between the three dimensional object and the CGH design plane. This permits Fourier, rather than Fresnel, replay of the 3D image.

According to a second aspect of this invention, a computer program for calculating an interference based CGH incorporating the above method for producing an interference based CGH may be employed.

According to a third aspect of this invention, an apparatus for the production of a 3D image comprises;

a computing means to calculate an interference based CGH for a virtual 3D object;

a coherent light source;

a spatial light modulation means capable of modulating a light wave with the interference based CGH;

the arrangement being such that illumination of the spatial light modulation means by the light source produces a 3D image of the virtual 3D object, wherein the computing means includes a computer program for calculating an interference based CGH as described above.

Preferably, a re-configurable spatial light modulator is employed as the spatial light modulation means.

This invention will now be described, by way of non-limiting example, with reference to the accompanying drawings wherein;

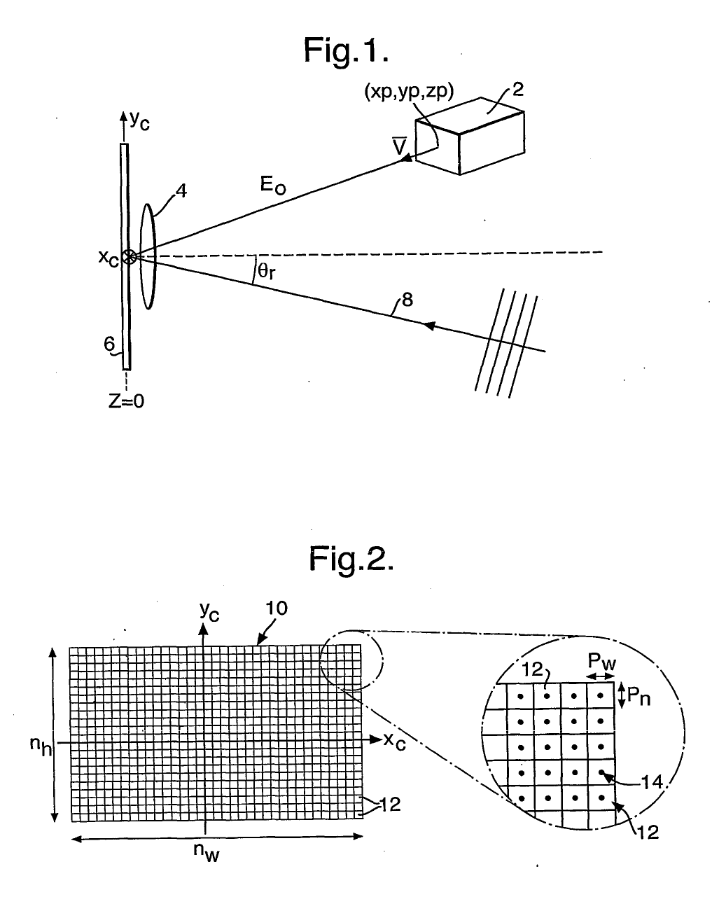

FIG. 1 is a schematic illustration of the Fourier geometry of interference based CGH generation calculations,

FIG. 2 gives schematic illustrations of a rectilinear CGH design plane geometry,

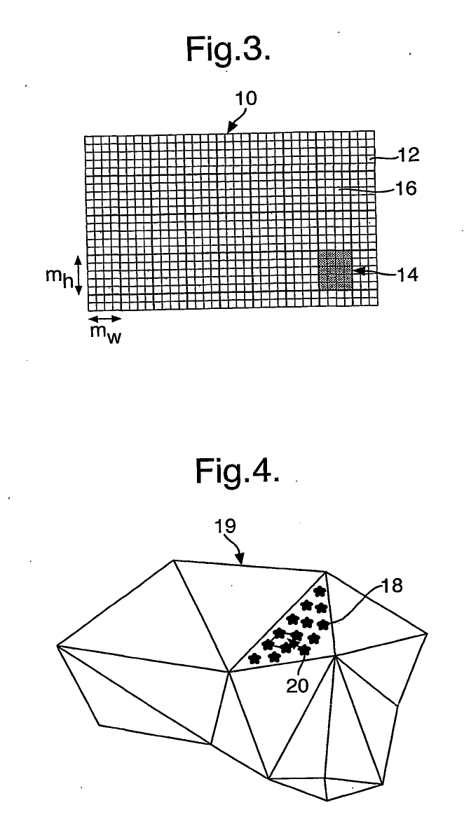

FIG. 3 is an illustration of a Macro Processing Grid (MPG), and

FIG. 4 is a schematic illustration of object points and object point clusters (OPCs) on a calculated 3D image.

Referring to FIG. 1, light from a plurality object points on a virtual three dimensional object (2) passes through a lens (4) and falls on the CGH design plane (6). The virtual 3D object (2), which may be imported from computer aided design packages, is populated with a distribution and density of object points appropriate to attain the required image resolution. The electric field at each CGH design plane pixel can then be calculated by summing the contribution to that pixel from the 3D object (2), populated with N object points.

The electric field at a given CGH pixel is given by:

$${E}_{F} = {\sum }_{p = 1}^{N} {a}_{p} {r}_{p}^{- 1} exp [ ⅈ {Φ}_{p} ] \qquad ( 1 )$$

where aₚ is the amplitude of light from the p^{th} object point, rₚ is the optical path length from the CDP pixel to the p^{t} object point and Φₚ is the phase for the p^{th} object point. A ray trace technique is employed to evaluate equation 1, and also has the advantage of directly calculating occlusion relationships between the p^{th} object point and each CGH design plane pixel.

A holographic interference pattern (i.e. the CGH) is then calculated by simulating the interference of the electric field produced by the 3D object (2) and a reference beam (8). The CGH thus contains all the information which is necessary to reconstruct the 3D image.

Referring to FIG. 2, the CGH design plane (10) can be formed from a rectilinear (i.e. x-y) grid of CGH pixels (12). The grid shown in FIG. 2 is n_{w} pixels wide by nₕ pixels high, and each individual pixel is p_{w} wide and pₕ high. In the centre of each pixel is a sample point (14) for which all the calculations relating to that pixel are made. The choice of the sampling point within the CGH design plane pixel is arbitrary, and in this embodiment is arbitrarily chosen to be central.

As described above, the computation of occlusion, amplitude and optical path length information between each pixel and each object point is computationally expensive. According to this invention, and as shown in FIG. 3, individual pixels (12) are grouped together in the CGH design plane (10) so as to define a Macro Processing Grid (MPG). The CGH design plane thus consists of a plurality of pixels (12), and pixels grouped into MPG cells (14). Each MPG cell is m_{w} pixels wide and mₕ pixels high. A point (such as 16) near the centre of each MPG cell is used for occlusion and light amplitude calculations, and every other pixel in the MPG cell takes the occlusion and light amplitude values calculated for the MPG cell centre point.

The use of MPG cells for occlusion and light amplitude calculations significantly reduces the number of ray tracing calculations required to calculate a CGH. This is due to the fact that instead of calculating amplitude and occlusion information for each pixel in the MPG, the calculation is performed for only one pixel within the MPG, and all other pixels are assumed to take an identical value.

Although defining a regular shaped MPG is convenient, it should in no way be seen as limiting the scope of the present invention. Any suitable group of pixels in the CGH design plane can be defined, and the occlusion properties and light amplitude properties of that group of pixels can be assumed identical.

Similarly, the requirement to use a pixel near to the MPG cell centre to perform the occlusion and light amplitude calculations is a non essential requirement. The occlusion and light amplitude calculations can be performed for any one pixel of the particular group of pixels, and the occlusion relationship and light amplitude of the other pixels in that group can then be taken, in subsequent calculations, to be those of the single pixel for which the calculation was performed.

It should be emphasised that the CGH design plane pixels are grouped together only for the purpose of occlusion processing and calculating light amplitude effects (aₚ). Once the occlusion relationship and light amplitude has been established for the group of pixels the calculation of the optical path length (rₚ) must still be computed on a per CGH pixel basis to ensure the resolution of the shape of the 3D image is not degraded.

Referring to FIG. 4, object points (18) of the virtual 3D object (19) can be grouped into object point clusters or OPCs (20). Object point clustering can be used in addition to, or instead of, grouping CGH design plane pixels into MPG cells as described above. OPCs may be formed by grouping object points into primitive shapes (e.g. squares, hexagons, etc), by facet, or by other suitable features of the geometry topology.

A specific object point of each OPC is used for occlusion and light amplitude calculations, and the other object points in the OPC are assumed to have the occlusion and light amplitude properties calculated for that object point. The use of OPCs for occlusion and light amplitude calculations significantly reduces the number of ray tracing calculations that are required. This is because the contributions from all object points of the OPC are assumed to be identical to the contribution of one object point of the OPC, thereby negating the need to calculate the contribution from each object point.

Again, it should be emphasised that the object points are clustered only for the purpose of occlusion processing and calculating light amplitude effects (aₚ). Once the occlusion relationship and light amplitude has been established for the OPC the calculation of the optical path length (rₚ) must still be computed on a per object point basis to achieve the accuracy required.

A typical CGH calculation would use approximately 10⁸ object points/m² to ensure that when the hologram is viewed in replay the observer believes the 3D surface to be solid and continuous. A similar number of CGH design plane pixels would also be used. For such a calculation, MPG cells of 100 or more CGH pixels and OPCs of approximately 5 object points would typically be used. This would produce a typical reduction of at least 500 in ray tracing computations, and in many circumstances the reduction may be very much larger.

The saving in computational load to calculate such CGHs has direct benefits in increasing the speed, and thus reducing the computation cost, with which CGHs may be calculated.

1. A method for producing an interference based computer generated hologram (CGH) comprising the steps of,
i) defining a number of object points; and
ii) defining a plurality of CGH pixels in a CGH design plane; and
iii) determining the total amplitude of light at each CGH pixel contributed by all non-occluded object points; and
iv) determining the optical path-length between each CGH pixel and each non-occluded object point; and
v) calculating the total electric field at each CGH pixel from the amplitude, occlusion and optical path-length information; and
vi) determining a CGH interference pattern from the total electric field calculated for each CGH pixel,
wherein, the occlusion information and amplitude contribution from at least some image points to at least some CGH pixels is taken to be the same as previously determined occlusion information and amplitude contributions.

2 A method for producing an interference based CGH as claimed in claim 1 wherein the amplitude and occlusion information calculated for a particular CGH pixel is used in the total electric field calculation of two or more CGH pixels.

3. A method for producing an interference based CGH as claimed in any preceding claim wherein a macro-processing grid (MPG) is formed from a plurality of MPG cells, wherein each MPG cell comprises a group of CGH design plane pixels and wherein the amplitude and occlusion information calculated for one CGH pixel of each MPG cell is used in the total electric field calculation of all pixels in that MPG cell.

4. A method for producing an interference based CGH as claimed in claim 3 wherein the MPG is a regular array of adjacent MPG cells.

5. A method for producing an interference based CGH as claimed in claim 3 or claim 4 wherein each MPG cell is a regular array of adjacent CGH design plane pixels.

6. A method for producing an interference based CGH as claimed in any of claims 3-5 wherein amplitude and occlusion information is calculated for the central point of the MPG.

7. A method for producing an interference based CGH as claimed in any preceding claim wherein the object points form object point clusters (OPCs) wherein each OPC comprises two or more object points and wherein the amplitude contribution of each object point in the OPC is taken, for the purpose of calculating occlusion effects and the amplitude at each CGH pixel, to be that calculated for one point of the OPC.

8. A method for producing an interference based CGH as claimed in claim 7 wherein the OPCs each contain two or more object points grouped into primitive shapes.

9 A method for producing an interference based CGH as claimed in either claim 7 or claim 8 wherein the number of object points in each OPC varies according to the facet size of that particular part of the virtual 3D image.

10. A method for producing an interference based CGH as claimed in any preceding claim and further comprising the step of calculating the effect on light of a lens placed between the three dimensional object and the CGH design plane.

11. A method for producing an interference based CGH as substantially hereinbefore described with reference to the accompanying drawings.

12. A computer program for calculating an interference based CGH incorporating the method for producing an interference based CGH as claimed in any of claims 1-11

13. An apparatus for the production of a 3D image that comprises;
a computing means to calculate an interference based CGH for a virtual 3D object;
a coherent light source;
a spatial light modulation means capable of modulating a light wave with the interference based CGH;
the arrangement being such that illumination of the spatial light modulation means by the light source produces a 3D image of the virtual 3D object,
wherein the computing means includes a computer program for calculating an interference based CGH as claimed in claim 12.

14 An apparatus for the production of 3D images as claimed in claim 13 wherein the spatial light modulation means comprises a re-configurable spatial light modulator.

15. An apparatus for the production of a 3D image as substantially hereinbefore described with reference to the accompanying drawings.
